(19) United States
(12) Patent Application Publication
(10) Pub. No.: US 2016/0033789 A1
(43) Pub. Date: Feb. 4, 2016

(54) FOLDABLE SPECTACLES

(71) Applicant: Maii IP B.V., Amsterdam (NL)

(72) Inventor: Keesjan Klant, Zwaanshoek (NL)

(21) Appl. No.: 14/814,722

(22) Filed: Jul. 31, 2015

(30) Foreign Application Priority Data
Jul. 31, 2014 (CH) 01172/14

(51) Int. Cl. G02C 5/00; G02C 11/00; G02C 5/20

(52) U.S. Cl. CPC G02C 5/006; G02C 5/20; G02C 11/10

(57) ABSTRACT

The invention relates to foldable spectacles (11) with a first folding mechanism (19) between two spectacle lenses (13), a second folding mechanism (21) between each of the two lenses (13) and a left or right side piece (17), whereby the foldable spectacles (11) can be folded into an M-shape, and a third folding mechanism (23) between the side piece (17) and at least one flap (25,27), which can be rotated on an axis aligned along the side piece (17), and together with the side piece (17) forms a protective housing, wherein the first, second and third folding mechanisms (19, 21, 23) each have a first and a second end position. The second folding mechanism (21) and the third folding mechanism (23) are linked to each other by means of an adjustment mechanism (31), so that a rotation of the side piece (17) effects a rotation of the at least one flap (25, 27).

### FIELD OF THE INVENTION

The invention relates to foldable spectacles according to the general term in claim 1.

### PRIOR ART

Foldable spectacles with at least one flap on the two side pieces are known from WO 2010/022900. The flaps are part of a protective housing for the folded spectacles. The disclosed folding spectacles comprise a first, second and third folding mechanism. The first folding mechanism is arranged on the connecting bridge of the two lenses, whereby the spectacle lenses can be folded onto each other. The second folding mechanism comprises the joint between one side piece and a spectacle lens in the known manner. The third folding mechanism serves to fold the flaps in and out. Owing to the three folding mechanisms, the foldable spectacles can be folded together to a very small size. In the folded condition, the foldable spectacles are protected by the folded out flaps. However, in particular when one pair of flaps is hinged at the top and one at the bottom on each of the two side pieces, a relatively large number of movements are required to fold the spectacles in or out.

### OBJECT OF THE INVENTION

The object of the present invention is to propose improved foldable spectacles that can be folded together with fewer movements than the foldable spectacles according to the prior art.

### DESCRIPTION

According to the invention, the object of foldable spectacles according to the general term of claim 1 is attained in that the second folding mechanism and the third folding mechanism are connected to each other in such a way by an adjustment mechanism that a rotation of the side piece effects a rotation of the at least one flap. Additional manual folding in and out of the flaps between the two end positions is no longer necessary with the foldable spectacles according to the invention, contrary to the prior art. Activating the second folding mechanism automatically leads to the flaps being rotated into the position corresponding to the second folding mechanism. The foldable spectacles can accordingly be folded in and out easily and quickly with only a few movements.

In a particularly preferred embodiment, the adjustment mechanism is realized as a guide rod with a first and a second end, wherein the first end is affixed with a joint on the outer rim of the lens or on an extension on the outer rim of the lens, and the second end is led in a linear movement along the longitudinal expanse of the side piece. The guide rod can also be a different mechanical actuator insofar as it can absorb shearing and tensile forces. The simple connection of the second and the third folding mechanism with just one mechanical component enables the reliable interaction of the side piece and the flaps.

For this purpose, guide pins are arranged on the second end, and can be moved on a guide rail of the side piece. In a surprisingly simple manner, the guide pins together with the guide rod attain the object of generating a linear movement out of the rotary movement of the second folding mechanism. A feasible alternative would also be a toothed bar, which drives a cogwheel.

The guide pins preferably also fulfill a further task, which is to facilitate that the ends of the guide pins engage in connecting links respectively formed on the flaps. The linear pin movement can be converted into a flap movement. The connecting links are provided, for example, on the sleeve surface of a hollow cylinder arranged on the flaps, whereby the pin movement can be transformed into a rotary movement of the flap.

In a further particularly preferable embodiment, the connecting links are formed in such a way that a linear movement of the guide pins rotate the flaps around the axes. For this purpose, a screw-shaped connecting link is formed on the sleeve surface. The pitch of the helicoid is exactly large enough that the first and second end positions of the second and the third folding mechanism match.

It is preferable for the guide rail to be covered by a spring element, in particular a leaf spring, whereby the guide rod can be locked in the first and the second end position of the guide rail. The leaf spring forms a part of the guide rail and is pretensioned in such a way that it presses the guide pins onto the guide rail. Depressions are provided in the guide rail at the first and the second end position, into which depressions the guide pins are pushed by the leaf spring. The foldable spectacles are thereby locked in the folded in and folded out position and require no further supports (for example, magnetic locks as proposed in the prior art). When exposed to shearing or tensile forces, the guide pins snap out of the depressions against the pretensioning of the leaf spring and they can be pulled or pushed along the guide rail.

Because the side piece is a support piece on which the at least one flap is arranged and which includes an ear hook part, the ear hook part can be used to serve as a lower part of the protective housing. For this purpose, the ear hook part can close the open bottom space between the lower flaps when the foldable spectacles are folded together.

In a further preferable embodiment, the ear hook part is arranged such that it can be swiveled on the at least one flap and forms a part of the protective housing when the foldable spectacles are folded together. The joint with which the ear hook part is connected to the at least one flap, preferably however to the lower flap, is provided with a stop surface. The ear hook part is thereby stable and does not wobble in its folded out position when the foldable spectacles are worn and in its folded in position as part of the protective housing.

It is advantageous for the first folding mechanism to be pretensioned with a spring element, which pretensions the lenses in both the first and the second end position. The spring element keeps the first folding mechanism stable in its first and second end positions, and a transitioning between these end positions is possible only by overcoming the pretensioning force of the spring element.

For this purpose, the spring element has an essentially Ω-shaped form with two legs and an elbow connecting the legs. This shape enables a simple support and simple fastening of the spring element on the spectacle frame. It would also be feasible to provide latches or closures (magnetic closures) in the end positions of the first folding mechanism.

In a further particularly preferred embodiment, the elbow has a bistable function, whereby the spring element can generate pretensioning in opposite directions. The spring element thereby holds the first folding mechanism in the first and the second end position without requiring further supports or latches.

Because receptacles for retaining elements designed for retaining the spring element on the spectacle lenses are preferably provided on the transition between the legs and the elbow, the spring element can be connected to the spectacle frame in a simple and reliable way by inserting retaining pins through receptacles in the spectacle frame.

In another embodiment, the foldable spectacles are provided with a frame in which a camera is integrated at least on one side, in the area of the second folding mechanism. The camera is always facing in the line of vision and does not need to be held, whereby it can be used without the user having to think about it, unpack it or adjust it.

In a further particularly preferred embodiment, the camera can be rotated out or in, in that it is integrated into a sphere, wherein the sphere can be rotated relative to the frame. In the rotated-in condition, the camera is shut and nearly invisible, as the sphere surface is adjusted to the surface of the spectacle frame. The turning of the sphere for using the camera is particularly simple and easy to handle by virtue of the spherical shape.

In a further preferred embodiment, the foldable spectacles can be provided with a display. The foldable spectacles can also be embodied as so-called “smart glasses”. When used as “smart glasses”, the foldable spectacles preferably serve as a support element for electronic devices, such as cameras, displays and mp3 players and not primarily as corrective lenses. Spectacle lenses are therefore not necessarily required for such an application of the foldable spectacles.

Additional benefits and characteristics result from the following description of an exemplary embodiment of the invention with references to the schematic drawings. In drawings not to scale, the following is shown:

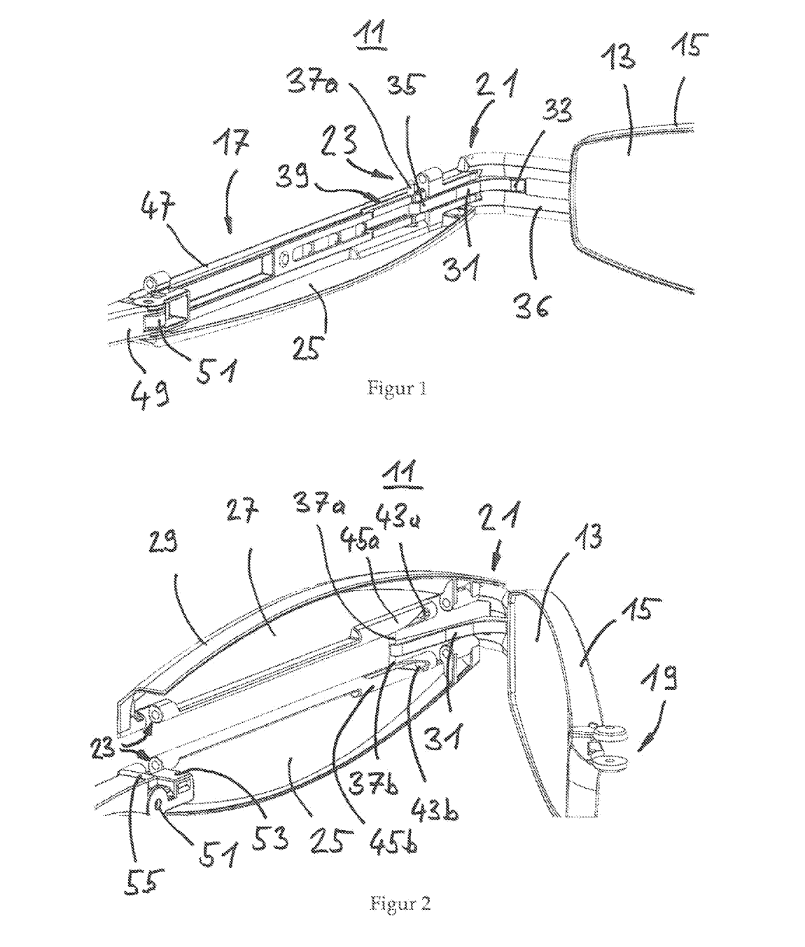

FIG. 1: a detail view of a control mechanism for the foldable spectacles according to the invention in a cut-open condition (missing upper flap);

FIG. 2: an axonometric view of the foldable spectacles in a partly folded condition with removed side piece;

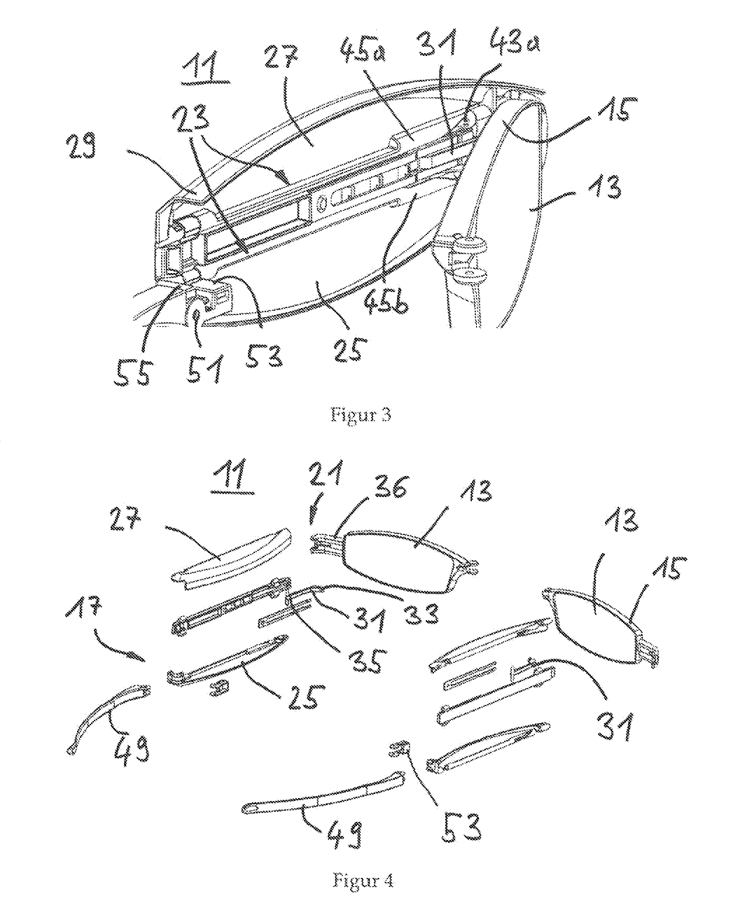

FIG. 3: an axonometric view of the foldable spectacles in an additional partly folded condition with side piece;

FIG. 4: an exploded view of the foldable spectacles according to the invention;

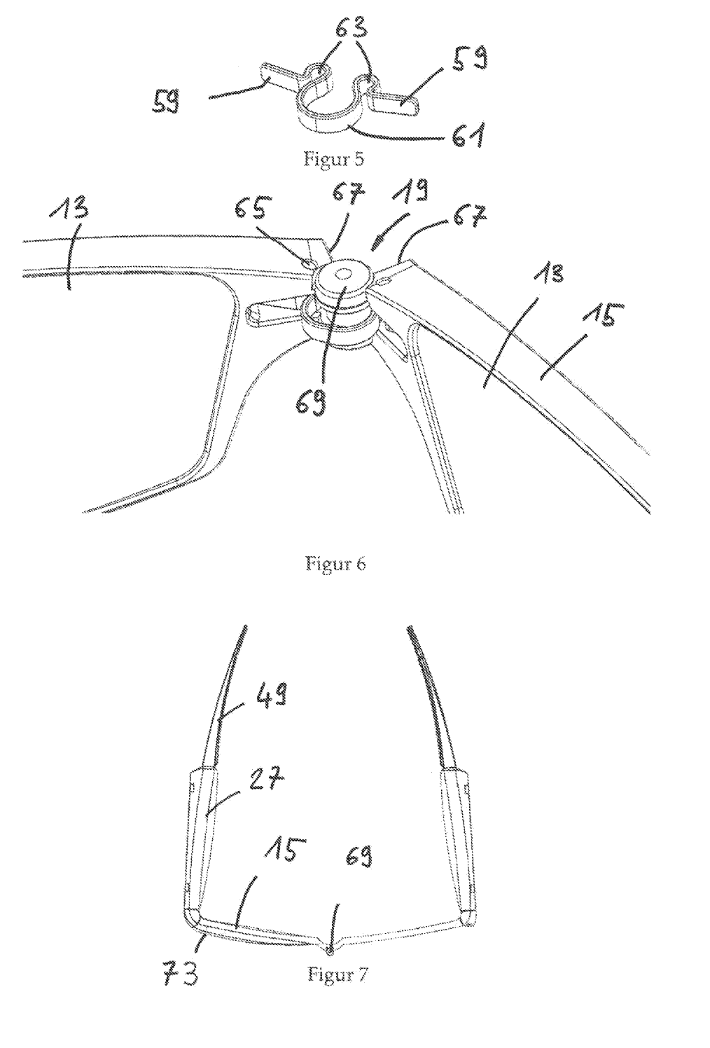

FIG. 5: a spring element for pretensioning of the spectacle lenses;

FIG. 6: an axonometric view of the spring element integrated into the first folding mechanism;

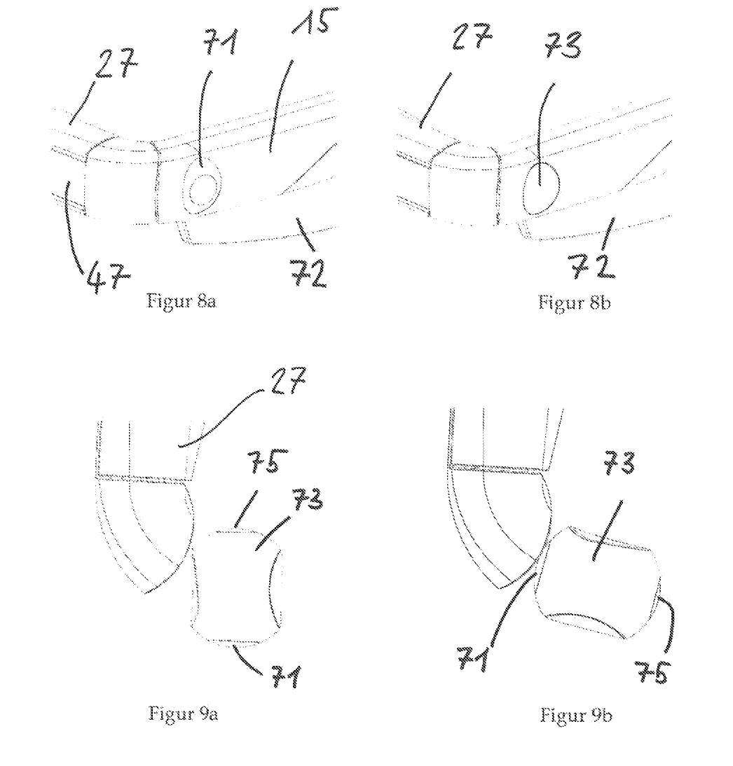

FIG. 7: a top view of the foldable spectacles in a “smart glasses” variant;

FIG. 8a: an axonometric view of a detail of the foldable spectacles with an integrated camera;

FIG. 8b: the camera in a folded in position in the spectacle frame;

FIG. 9a: a top view of the camera cut open; and

FIG. 9b: the camera cut open in the folded in position in the spectacle frame;

In FIGS. 1 to 4, partial views of foldable spectacles are shown, which are referred to collectively with reference number 11. The foldable spectacles 11 include two spectacle lenses 13, a spectacle frame 15 and two side pieces 17. Also feasible is that the lenses are not encased in a frame 15, which would then be so-called frameless spectacles. The two spectacle lenses 15 can be folded onto each other with their outsides by means of a first folding mechanism 19.

A second folding mechanism 21 is provided between the spectacle frame 15 and the side pieces 17. Through the second folding mechanism, the side pieces 17 can be folded onto the spectacle lenses 13.

A third folding mechanism 23 enables a lower and an upper flap 25, 27 to be folded in and out along the longitudinal axis of the side piece 17, thus that it can be rotated between a first and a second end position. As described in detail in WO 2010/022900, the upper flap 27 has an angle area 29, which can cover the upper rim of the spectacle lens in the first end position and is folded out on the inside of the side piece 17 in the second end position.

The second folding mechanism 21 and the third folding mechanism 23 are linked to each other by an adjustment mechanism 31. Preferably, the adjustment mechanism is implemented in the form of a guide rod 31 or an actuator 31. The guide rod 31 has a first end 33 and a second end 35. The first end 33 is provided with a joint and linked to the outer rim of the spectacle lenses 13 or the frame 15, wherein the rim can be embodied as extension 36. When the second folding mechanism 21 is activated by rotating the side piece 17 to the inside of the spectacle lens 13, the second end 35 of the guide rod 31 also moves. So that the movement of the second end is guided, a guide pin 37a, 37b is formed or arranged on the guide rod 31 at the top and the bottom of the second end 35. The guide pins 37a, 37b serve two functions:

On the one hand, the guide pins 37a, 37b are led in a guide rail 39 of the side piece 17. The guide rail 39 effects that the guide pins 37a, 37b are forced into a linear movement along the longitudinal expanse of the side piece 17. In order to be able to engage the guide pins 37a, 37b in a first and a second end position, which correspond to the opening and closing positions of the second folding mechanism 21, a leaf spring 41 is provided. The leaf spring 41 is pretensioned and presses the guide pins 37a, 37b into indentations (not shown in the Figures), which are provided on the two ends of guide rail 39. The guide pins therefore hold the second folding mechanism 21 in its first and second end positions. On exertion of spring pressure, the guide pins 37a, 37b leave the indentations and move into guide rail 39.

On the other hand, the guide pins 37a, 37b facilitate that their linear movement effects a rotational movement of the upper and lower flaps 25, 27. To achieve this, the guide pins 37a, 37b are inserted into connecting links 43a, 43b of flaps 25, 27. The connecting links 43a, 43b form a partly screw-shaped conduit on the sleeve surface of a rotating cylinder 45a, 45b extending in the longitudinal direction of the side piece. The screw-shaped conduit transforms the linear movement of the guide pin 37a, 37b into a rotational movement of flaps 25, 27. Flaps 25, 27 do not have to be folded in or out separately for the protection of the spectacle lenses 13, as is the case in the prior art, and instead they fold automatically in and out synchronously with the side piece movement.

As is already known from the prior art, the side piece 17 includes a support piece 47 and an ear hook part 49. The ear hook part is hinged onto the lower flap 27 and closes the protective housing formed of flaps 25, 27 on the bottom side by rotation around the first joint 51. The first joint 51 has a first stop surface 53, against which it stops on the support piece 47 when the lower flap is folded in. A second stop surface 55 is formed on the ear hook part 49 as a limit stop when the ear hook part is folded out for wearing the foldable spectacles 11.

The first folding mechanism 19 is pretensioned by a spring element 57, preferably having a Ω-shaped form. Accordingly, the spring element 57 comprises two legs 59 and one elbow 61 linking the legs. On the transition from the legs 59 to the elbow 61, receptacles 63 are provided. Retaining devices in the form of retaining pins 65 can be inserted into the receptacles 63. When the first folding mechanism 19 is moved, the spring element 57 is supported on the spectacle frame with its legs 59 and is fixed on the spectacle frame by means of the retaining pins 59. In the first end position, the spectacle lenses 13 are folded out and pretensioned in this position by spring element 57. The spectacle lenses 13 are thereby pressed together on third stop surfaces 67. FIG. 6 presents an axonometric front view of the foldable spectacles 11, which shows that the spectacle lenses 13 can be swiveled to the front around a second joint 69. If the spectacle lenses 13 are swiveled to the back to fold the foldable spectacles 11 together, the spring element resists up to a certain rotation angle. If this rotation angle is exceeded, the spectacle lenses are pressed in the opposite direction by the spring element 57. The spectacle lenses 13 are thereby pretensioned in the folded end position of the first folding mechanism. The spring element is therefore bistable, as it can generate pretensioning in two opposite directions.

A further characteristic relates to at least one camera 71 integrated into the foldable spectacles and is shown in FIGS. 7 to 9. The foldable spectacles 11 can therefore also be embodied as so-called “smart glasses”. This marketing term is understood to mean that spectacles can be equipped with additional electronic features, such as a camera, an integrated mp3 player or an active display 72, in which SMS messages or other functions (navigation and other displays, which are also provided on a “smartphone”). Such “smart glasses” do not necessarily have to be provided with spectacle lenses and can also serve only as a carrier for camera 71, display 72, etc. Camera 71 has the advantage that it does not need to be held but that a photo can be taken at any time in whichever direction the wearer of the spectacles is looking.

Camera 71 is positioned in the area of the second folding mechanism, for example, in the extension 36 and is integrated into a sphere 73. Sphere 73 is integrated into the frame 15 and held rotatable in it. It is feasible that the rotation of sphere 73 can be locked in frame 15 and that it can be rotated only by authorized persons. FIGS. 9a and 9b do not show the frame 15 for reasons of clarity. The sphere is shaped in such a way that it is adjusted to the surface of the frame. FIG. 8b shows that the sphere 73 is completely integrated into the spectacle frame 15 in the rotated in position. In this position, camera 71 is shut, since it is rotated into the spectacle frame 15. When camera 71 is rotated into the frame, the surface of sphere 73 and the frame 15 form one common surface. Also, a second camera 75 can be integrated into the sphere, and is preferably arranged opposite the first camera 71, in sphere 73. Cameras 71, 75 can have different resolutions.

Legend:

| | |
|---|---|
| 11 | Foldable spectacles |
| 13 | Spectacle lenses |
| 15 | Spectacle frame |
| 17 | Side pieces |
| 19 | First folding mechanism |
| 21 | Second folding mechanism |
| 23 | Third folding mechanism |
| 25 | Lower flap |
| 27 | Upper flap |
| 29 | Angle range |
| 31 | Adjustment mechanism, guide rod, actuator |
| 33 | First end of the guide rod |
| 35 | Second end of the guide rod |
| 36 | Extension of the spectacle frame |
| 37a, 37b | Guide pins |
| 39 | Guide rail |
| 41 | Leaf spring |
| 43a, 43b | Connecting links |
| 45a, 45b | Rotating cylinder |
| 47 | Support piece |
| 49 | Ear hook part |
| 51 | First joint |
| 53 | First stop surface |
| 55 | Second stop surface |
| 57 | Spring element |
| 59 | Leg |
| 61 | Elbow |
| 63 | Receptacles |
| 65 | Retaining pin |
| 67 | Third stop surface |
| 69 | Second joint |
| 71 | First camera |
| 72 | Display |
| 73 | Sphere |
| 75 | Second camera |

1-15. (canceled)

16. Foldable spectacles (11) comprising:
a first folding mechanism (19) between two spectacle lenses (13);
a second folding mechanism (21) respectively between one of the two lenses (13) and a left or right side piece (17), whereby the foldable spectacles (11) can be folded into an M-shape;
a third folding mechanism (23) between the side piece (17) and at least one flap (25, 27), which can be rotated on an axis aligned along the side piece (17) and which together with the side piece (17) forms a protective housing, wherein the first, second and third folding mechanisms (19, 21, 23) are respectively provided with a first and a second end position; and
the second folding mechanism (21) and the third folding mechanism (23) are linked to each other by means of an adjustment mechanism (31), so that a rotation of the side piece (17) effects a rotation of the at least one flap (25, 27).

17. Foldable spectacles according to claim 16, further comprising the adjustment mechanism (31) is realized as a guide rod with a first and a second end (33, 35), wherein the first end (33) is affixed with a joint on the outer rim of the lens (13) or an extension (36) on the outer rim of the lens (13), and in that the second end (35) is led in a linear movement along the longitudinal expanse of the side piece (17).

18. Foldable spectacles according to claim 17, further comprising the guide pins (37a, 37b) are arranged on the second end (35), and can be moved on a guide rail (39) of the side piece (17).

19. Foldable spectacles according to claim 18, further comprising the ends of the guide pins (37a, 37b) engage in connecting links (43a, 43b) respectively provided on the flaps (27, 29).

20. Foldable spectacles according to claim 19, further comprising the connecting links (43a, 43b) are embodied in such a way that a linear movement of the guide pins (37a, 37b) rotates the flaps (27, 29) around the axis.

21. Foldable spectacles according to claim 20, further comprising the guide rail (39) is covered by a spring element, in particular a leaf spring (41), whereby the guide rod (31) can be locked in the first and the second end position.

22. Foldable spectacles according to claim 21, further comprising the side piece (17) comprises a support piece (47) on which at least one flap (25, 27) is arranged, and further comprises an ear hook part (49).

23. Foldable spectacles according to claim 22, further comprising the ear hook part (49) is arranged in such a way that it can be rotated on the at least one flap (27, 29) and in that it forms a part of the protective housing in the folded condition of the foldable spectacles (11).

24. Foldable spectacles according to claim 23, further comprising the first folding mechanism (19) is pretensioned by a spring element (57), which pretensions the spectacle lenses (13) in both the first and the second end position.

25. Foldable spectacles according to claim 24, further comprising the spring element (57) has an essentially 0-shaped form with two legs (59) and an elbow (61) connecting the legs (59).

26. Foldable spectacles according to claim 25, further comprising the elbow (61) has a bistable function, whereby the spring element (57) can generate pretensioning in opposite directions.

27. Foldable spectacles according to claim 26, further comprising the transition from the legs (59) and the elbow (61), receptacles (63) are provided for retaining devices designed to hold the spring element (57) on the spectacle lenses (13).

28. Foldable spectacles according claim 27, further comprising the foldable spectacles (11) comprise a frame (15) into which a camera (71, 75) is integrated at least on one side, in the area of the second folding mechanism (21).

29. Foldable spectacles according to claim 28, further comprising the camera (71, 75) can be rotated out or in, in that it is integrated into a sphere (73), wherein the sphere (73) can be rotated relative to the frame (15).

30. Foldable spectacles according to claim 29, further comprising the foldable spectacles (11) are provided with a display (72).
